(19) United States
(12) Patent Application Publication
(10) Pub. No.: US 2023/0015196 A1
(43) Pub. Date: Jan. 19, 2023

(54) PRESSURE SENSITIVE HEATING ELEMENT AND METHOD FOR MANUFACTURING THE SAME

(71) Applicants: HYUNDAI MOTOR COMPANY, Seoul (KR); Kia Corporation, Seoul (KR)

(72) Inventors: Kyong Hwa SONG, Yongin-si (KR); Minjae LEE, Seongnam-si (KR); Byung-Wook KIM, Seongnam-si (KR); Deok Woo YUN, Hwaseong-si (KR); Gwansik KIM, Suwon-si (KR); Ji Hyun LEE, Seongnam-si (KR); Sang Hyun JANG, Yongin-si (KR); Geon Hee PARK, Gunpo-si (KR); Yoon Jin KIM, Yongin-si (KR)

(73) Assignees: HYUNDAI MOTOR COMPANY, Seoul (KR); Kia Corporation, Seoul (KR)

(21) Appl. No.: 17/513,198

(22) Filed: Oct. 28, 2021

(30) Foreign Application Priority Data
Jul. 6, 2021 (KR) 10-2021-0088755

(51) Int. Cl. H05B 3/14; H05B 3/34; H05B 3/03; H05B 3/16

(52) U.S. Cl. CPC H05B 3/141; H05B 3/34; H05B 3/03; H05B 3/16; H05B 2203/017

(57) ABSTRACT

An exemplary embodiment of the present disclosure provides a pressure sensitive heating element including a front electrode and a foam including a conductive material attached to one or both surfaces of the front electrode, and a method for manufacturing the same.

### CROSS-REFERENCE TO RELATED APPLICATION

This application claims the benefit of priority to Korean Patent Application No. 10-2021-0088755 filed on Jul. 6, 2021 in the Korean Intellectual Property Office, the entire contents of which are incorporated herein by reference.

### BACKGROUND

### (a) Technical Field

The present disclosure relates to a pressure sensitive heating element for reducing energy consumption and providing various temperature ranges in proportion to a pressure size and a manufacturing method thereof.

### (b) Description of the Related Art

Vehicles have car seats so that a driver or a passenger may sit therein comfortably and drive and ride. As the industry has gradually developed, the automobile industry has also continued to develop, and many safer, more convenient, and more comfortable car seats have been developed and sold for not only driving performance of vehicles but also driving comfort of drivers or passengers.

In winter, when a driver seats on a car seat, his body temperature drops due to a low temperature inside the car, and in this case, even if the driver turns on the ignition to operate a heater to operate a fan heater, it takes much time to heat an indoor area of the vehicle. Therefore, in order to eliminate such drivers' inconvenience, recently, a heating seat for automobiles having a heating function has been developed.

A heating element of a sheet for automobiles of a related art is in the form of a conductive metal wire or metal plate such as copper or silver and has only a simple heating function, without being changed in shape of the heating element itself, and when a system power including the heating element is turned on, a temperature of the metal wire or metal plate is simply uniformly increased but it is not possible to perform partial and selective heating. In addition, although there is a heating system that performs heating by pressure sensitivity, a separate sensing unit detecting a human body load and a heating part generating heat are simply connected, that is, only respective functional parts of detecting and heating are provided.

The above information disclosed in this Background section is only for enhancement of understanding of the background of the disclosure, and therefore it may contain information that does not form the prior art that is already known in this country to a person of ordinary skill in the art.

### SUMMARY

The present disclosure has been made in an effort to provide a pressure sensitive heating element and a method for manufacturing the same, having advantages of achieving both pressure detection and heating without the necessity of installing a pressure sensitive detecting unit, being freely controlled in shape and size, and having a high restoring force after compression.

The present disclosure has also been made in an effort to provide a pressure sensitive heating element and a method for manufacturing the same, in which heating is performed selectively only in a portion with pressure sensitivity and the degree of heating varies depending on the degree of pressure.

An exemplary embodiment of the present disclosure provides a pressure sensitive heating element including a front electrode; and a foam including a conductive material attached to one or both surfaces of the front electrode.

The conductive material may be located on an inner surface of the foam, and when pressure is applied to the foam, an electrical contact of a certain level or higher may be formed to supply current to the front electrode.

The front electrode may include a plurality of electrode surfaces; a connection portion electrically connecting the plurality of electrode surfaces; and a power connection portion configured to supply power to the front electrode.

An electrical contact of a certain level or higher may be formed on a surface to which pressure is applied, among the plurality of electrode surfaces, to supply current to the front electrode.

A total area of the plurality of electrode surfaces may be 25% to 50% of a total area of the front electrode.

The connection portion may be in a form of a wire.

A first urethane film may be attached to a surface to which the foam is not attached in the electrode surface and the power connection portion, and a second urethane film may be attached to both surfaces of the connection portion.

The conductive material may be carbon nanotubes (CNT).

The foam may be a polyurethane foam.

A density of the polyurethane foam may be 0.03 g/cc to 0.04 g/cc.

Another exemplary embodiment of the present disclosure provides a method for manufacturing a pressure sensitive heating element including: manufacturing a foam including a conductive material; preparing a front electrode; and attaching the foam to one or both surfaces of the front electrode.

The manufacturing of a foam including a conductive material may include; preparing a foam; preparing a coating solution; and coating the prepared foam with the prepared coating solution.

The preparing of a coating solution may include: mixing a conductive material, a dispersant, and a solvent to prepare a conductive material dispersion; mixing a binder and a solvent to prepare a binder solution; and; and mixing the conductive material dispersion and the binder solution.

In the preparing of a binder solution, the binder may be 3.5 parts by weight to 5.5 parts by weight based on 100 parts by weight of the binder solution.

In the mixing of the conductive material dispersion and the binder solution, a mass ratio of the binder solution to the conductive material dispersion may range from 2:1 to 4:1.

The coating of a prepared foam with a prepared coating solution may include: dip-coating the foam with the prepared coating solution; removing an excessively absorbed coating solution in the dip-coating; and drying until the solvent is completely removed.

In the attaching of a foam to one or both surfaces of the front electrode, the foam may be attached using a conductive or non-conductive adhesive.

According to the pressure sensitive heating element and a method for manufacturing the same according to one aspect of the present disclosure, it is possible to control a temperature by changing a shape by pressure to perform heating only in a portion with the pressure, so energy consumption due to heating of an entire surface may be reduced, and since heating is controlled proportionally according to a pressure magnitude, various temperature ranges may be provided according to a portion, pressure sensitivity and heating may be simultaneously performed, and a restoring force after compression is large.

### BRIEF DESCRIPTION OF THE DRAWINGS

FIG. 1 shows a conceptual diagram of a pressure sensitive HEATING applied to the present disclosure.

FIG. 2 is a schematic diagram showing a process of manufacturing a pressure sensitive heating element according to an exemplary embodiment of the present disclosure.

FIG. 3 shows an image showing a compression method in a repeated compression experiment of a pressure sensitive heating element according to an exemplary embodiment of the present disclosure.

FIG. 4 shows a pressure sensitive heating element manufactured according to Example 3 of the present disclosure.

FIG. 5 is a graph showing measurement of resistance and current of a sample over time during a test of Experimental Example 2 of the present disclosure.

FIG. 6 shows an infrared (IR) image of a heating temperature and heating distribution state of the sample measured in Experimental Example 2 of the present disclosure.

FIG. 7 shows a pressure sensitive heating element manufactured according to Example 4 of the present disclosure.

FIG. 8 is a graph showing measurement of resistance and current of the sample over time during a test of Experimental Example 3 of the present disclosure.

FIG. 9 shows an infrared (IR) image of a heating temperature and a heating distribution state of the sample measured in Experimental Example 3 of the present disclosure.

FIG. 10 shows a pressure sensitive heating element manufactured according to Example 5 of the present disclosure.

FIG. 11 is a graph showing measurement of resistance and current of a sample over time during a test of Experimental Example 4 of the present disclosure.

FIG. 12 shows an infrared (IR) image of a heating temperature and a heating distribution state of the sample measured in Experimental Example 4 of the present disclosure.

FIG. 13 shows a pressure sensitive heating element manufactured according to Example 6 of the present disclosure.

FIG. 14 is a graph showing measurement of resistance and current of a sample over time during a test of Experimental Example 5 of the present disclosure.

FIG. 15 shows an infrared (IR) image of a heating temperature and a heating distribution state of the sample measured in Experimental Example 5 of the present disclosure.

### DETAILED DESCRIPTION OF THE EXEMPLARY EMBODIMENTS

Although terms such as first, second, and third are used for describing various parts, various components, various areas, and/or various sections, the present disclosure is not limited thereto. Such terms are used only to distinguish any part, any component, any area, any layer, or any section from the other parts, the other components, the other areas, the other layers, or the other sections. Thus, a first part, a first component, a first area, a first layer, or a first section which is described below may be mentioned as a second part, a second component, a second area, a second layer, or a second section without departing from the scope of the present disclosure.

Here, terminologies used herein are merely used to describe a specific exemplary embodiment, and are not intended to limit the present disclosure. A singular form used herein includes a plural form as long as phrases do not express a clearly opposite meaning. The term “include” used in the specification specifies specific characteristics, a specific area, a specific essence, a specific step, a specific operation, a specific element, and/or a specific ingredient, and does not exclude existence or addition of the other characteristics, the other area, the other essence, the other step, the other operation, the other element, and/or the other ingredient.

When it is mentioned that a first component is located “above” or “on” a second component, the first component may be located directly “above” or “on” the second component or a third component may be interposed therebetween. In contrast, when it is mentioned that a first component is located “directly above” a second component, a third component is not interposed therebetween.

In addition, unless otherwise specified, % means wt %, and 1 ppm is 0.0001 wt %.

Although not otherwise defined, all terms used herein, including technical terms and scientific terms, have the same meanings as those generally understood by those skilled in the art to which the present disclosure pertains. Terms defined in a generally used dictionary are interpreted as meanings according with related technical documents and currently disclosed contents, and are not interpreted as ideal meanings or very formal meanings unless otherwise defined.

Hereinafter, exemplary embodiments of the present disclosure will be described with reference to the accompanying drawings.

### Pressure Sensitive Heating Element

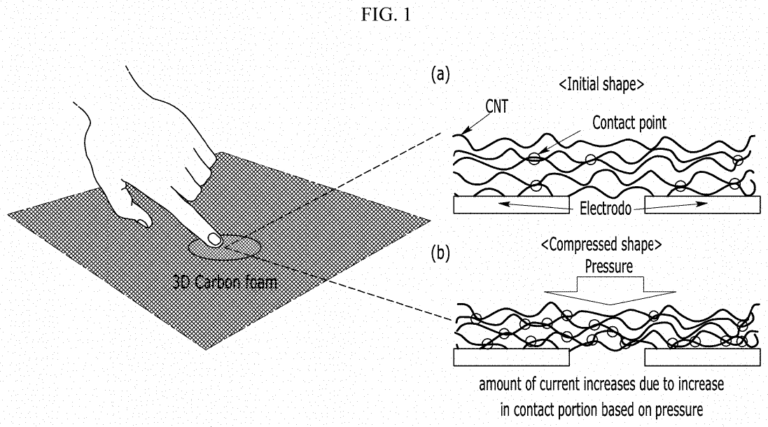

FIG. 1 is a conceptual diagram of pressure sensitive heating according to one exemplary embodiment of the present disclosure.

Specifically, referring to the conceptual diagram of heating, a foam coated with a conductive material is attached to an electrode of a heating element, and in this state, when pressure is applied to the foam, a contact portion between conductive materials in the foam increases and the amount of current increases in the portion to cause heating.

A pressure sensitive heating element according to an exemplary embodiment of the present disclosure may include a front electrode and a foam including a conductive material attached to one or both surfaces of the front electrode.

The conductive material is located on an inner surface of the foam, and when pressure is applied to the foam, an electrical contact of a certain level or higher is formed to supply current to the electrode. In the same principle as the conceptual diagram of the pressure sensitive heating of FIG. 1, when pressure is applied to the foam, contact between the conductive materials increases to form an electrical contact of a certain level or higher, and accordingly, electrical conduction increases to allow a current to flow and cause heating. That is, by applying the conductive material to the foam, both pressure detection and heating may be achieved by the material as a foam, without having to install a pressure sensitive detection unit.

The conductive material may be carbon nanotubes (CNTs), and the foam may be polyurethane foam. Since the polyurethane foam has excellent flexibility and elasticity, it may be in an appropriate form to impart flexibility and elasticity of the pressure sensitive heating element itself. In addition, as carbon nanotubes (CNTs), a conductive material, multi-walled carbon nanotubes (MWNTs), single-walled carbon nanotubes (SWNTs), and double-walled carbon nanotubes (DWNT) may all be used, and conductivity may be imparted to the foam using these CNTs.

A density of the polyurethane foam may be 0.03 g/cc to 0.04 g/cc, and preferably, 0.031 f/cc to 0.037 f/cc. CNT coating may be smoothly made on the polyurethane foam that satisfies the density in the above range, but if the density of the polyurethane foam is too low (e.g., less than 0.03 g/cc), pressure sensitive sensing sensitivity is inferior, and if the density is too high (e.g., more than 0.04 g/cc), the CNT dispersion may not be smoothly absorbed.

In addition, as described in the method for manufacturing the pressure sensitive heating element, the pressure sensitive heating element according to one exemplary embodiment of the present disclosure is manufactured by coating a foam with a conductive carbon material, so that a shape and size may be freely adjusted. In addition, pressure may be easily detected due to flexibility of the foam, and the foam has a high restoring force after compression due to high elastic modulus thereof.

The front electrode may be formed of a conductive material such as copper (Cu) or silver (Ag), and specifically may be a thin-film type copper electrode. Using the front electrode, heating may take place on the front surface of the attached foam.

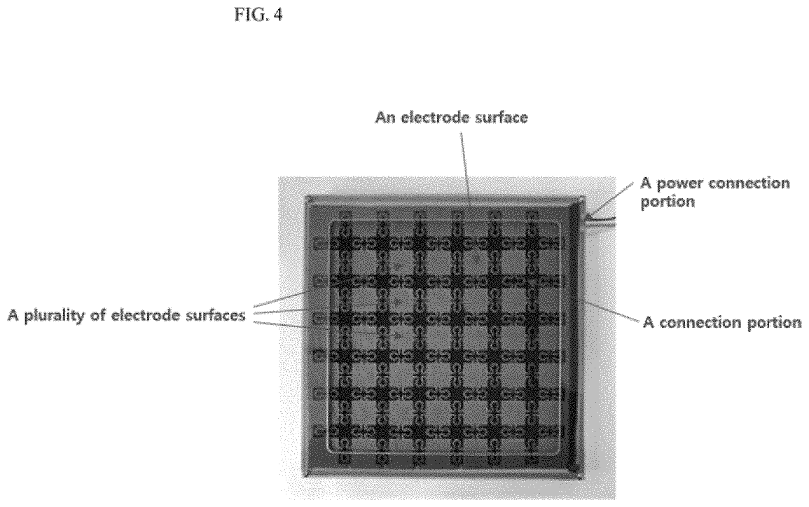

As shown in FIG. 4, the front electrode includes a plurality of electrode surfaces, a connection portion electrically connecting the electrode surfaces, and a power connection portion supplying power to the electrode.

An electrical contact of a certain level or higher may be formed on a surface, among the plurality of electrode surfaces, to which a pressure is applied, to supply current to the electrode. In general, a heating wire and a heating pad have the same amount of current flowing along a conductive wire, and thus, the heating element generates the same amount of heat in various positions of the heating element. However, in the pressure sensitive heating element according to one exemplary embodiment of the present disclosure, the amount of current flowing may vary according to the degree of pressure and heating may be controlled accordingly, and thus, only a portion to which a certain pressure or more is applied may be heated, thereby allowing partial and selective heating based on pressure sensitivity to obtain energy.

A total area of the plurality of electrode surfaces may be 25% to 50% of a total area of the front electrode. If the total area of the plurality of electrode surfaces compared to the total area of the front electrode is too small (e.g., less than 25%), the heating function according to the pressure sensitivity is not performed properly, and thus, it may be difficult to immediately feel a temperature increase during pressurization, and if the total area of the plurality of electrode surfaces is too large (e.g., more than 50%), it may be difficult to cause selective and selective heating based on pressure sensitivity, and thus, energy efficiency may be lowered and pressure transfer due to a change in the form of the foam may be limited by the electrode surface. Preferably, the total area of the plurality of electrode surfaces may be 30% to 47% of the total area of the front electrode.

The connection portion may be in the form of a wire. In the case of applying pressure to the pressure sensitive heating element, it may be necessary for the electrode to be changed in form as well when a height of the foam changes, and thus, the connection portion may be manufactured in the form of a wire to provide flexibility to the electrode.

A protective film may be attached to a surface to which the foam is not attached in the electrode surface and the power connection portion, and a protective film may be attached to both surfaces of the connection portion. The protective film may be used as a base film, and by attaching the protective film, the electrode is prevented from being damaged and maintained in shape even if the pressure sensitive heating element is repeatedly contracted and restored. Therefore, the type of film is not limited to a specific film, and any type may be used as long as it has good elasticity, transparency, and thermal stability. Preferably, a urethane film may be used.

A polyurethane foam of 25% may have 0.045 kgf/cm² or more of hardness, 35 ppi to 100 ppi of porosity, 140 kPa or more of tensile strength, and 180% or more of elongation. By satisfying these properties, the polyurethane foam may have excellent shape retention ability after compression, durability against repeated shape changes, and lightness of the foam, when changed in shape by pressure. In addition, in the case of using a polyurethane foam exceeding 100 ppi, an upper limit of the porosity, a CNT coating solution may be trapped inside a cell, resulting in a phenomenon in which resistance rapidly increases.

To sum up, the pressure sensitive heating element according to one exemplary embodiment of the present disclosure does not adopt a method of connecting an existing pressure measurement method such as a pressure sensor and a heating system for pressure switching but adjusts the amount of current based on pressure using a sponge-type conductive material, thereby implementing both a sensor and a control system. When this method is applied to a seat, heating characteristics appear only in a portion to which pressure is applied when a passenger is seated, and unnecessary heat or energy loss does not occur in a portion where heating is not required. Accordingly, an overall system is simple and good energy efficiency may be obtained. Such a pressure sensitive heating element may be applied to a slim design seat of a future self-driving car, etc. in connection with a reduction of power consumption and sensitivity of the passenger's body.

### Method for Manufacturing Pressure Sensitive Heating Element

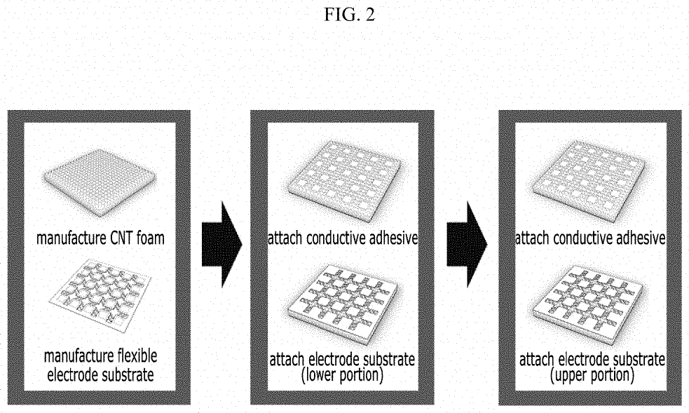

FIG. 2 is a schematic view of a process of manufacturing a pressure sensitive heating element according to an exemplary embodiment of the present disclosure.

A method for manufacturing a pressure sensitive heating element as an implementation example of the present disclosure may include: preparing a foam including a conductive material; preparing a front electrode; and attaching the foam including a conductive material to one or both surfaces of the front electrode. The front electrode may include an electrode surface, a connection portion, and a power connection portion.

Preparing of a foam including a conductive material may include preparing the foam; preparing a coating solution; and coating the prepared foam with the prepared coating solution. The foam may be polyurethane foam. By using a polyurethane foam with excellent flexibility and elasticity, flexibility and elasticity may be imparted to the pressure sensitive heating element.

The preparing of a coating solution may include mixing a conductive material, a dispersant, and a solvent to prepare a conductive material dispersion; mixing a binder and a solvent to prepare a binder solution; and mixing the conductive material dispersion and the binder solution. The conductive material may be carbon nanotube (CNT), and specifically, all of MWNT, SWNT, and DWNT may be used. The conductive material may impart conductivity to the foam, may have a diameter of 6 to 40 nm and a length of 1 to 200 μm, and may be 0.1875 to 0.375 wt % based on a total mass of the conductive material dispersion. The dispersant may be introduced to facilitate dispersion of the conductive material, and a dispersing agent having excellent dispersing power may be selected from among general BYK-type dispersants or amphoteric surfactants such as Triton-X100. The solvent used to prepare the conductive material dispersion may be selected in consideration of the dispersibility of the conductive material, and the solvent used for preparing the binder solution may be selected in consideration of solubility of the binder and affinity with the foam material.

In the preparing of the binder solution, the binder may be in an amount of 3.5 parts by weight to 5.5 parts by weight based on 100 parts by weight of the binder solution. The binder may be added for bonding the conductive material and the foam and may be selected in consideration of tensile strength, elongation, and adhesive strength of the foam. If the content of the binder is too small (e.g., less than 3.5 parts by weight), it may be difficult to stably attach the conductive material dispersion to the foam, and thus, even if the foam is coated with the prepared coating solution, durability is lowered so the conductive material may be easily detached from the foam, and if the content of the binder is too large (e.g., more than 5.5 parts by weight), a resistance reduction rate during compression may increase and resistance recovery characteristics after compression may decrease.

In the mixing of the conductive material dispersion and the binder solution, a mass ratio of the binder solution to the conductive material dispersion may range from 2:1 to 4:1. Preferably, the mass ratio may range from 2.5:1 to 3.5:1. If the mass ratio of the binder solution to the conductive material dispersion is too small (e.g., less than 2:1 or 2.5:1), the conductive material cannot be stably attached to the foam, resulting in poor durability, and if the mass ratio of the binder solution to the conductive material dispersion is too large (e.g., more than 4:1 or 3.5:1), the conductive material may be covered with a polymer binder, resulting in poor conductivity.

The coating of the prepared foam with the prepared coating solution may include dip-coating the foam with the prepared coating solution; removing an excessively absorbed coating solution in the dip-coating; and drying until the solvent is completely removed. The coating process may be repeated 2 to 5 times depending on target resistance.

The attaching of the foam including a conductive material to one or both surfaces of the front electrode may be attaching the foam using a conductive or non-conductive adhesive. The conductive adhesive may be carbon ink, Ag ink, or the like. In the case of using a conductive adhesive, the conductive adhesive may be applied to the entire electrode surface of the front electrode so as to be adhered to a foam and then dried, and in the case of using a non-conductive adhesive, the non-conductive adhesive may be attached to a portion of the electrode surface of the front electrode and a foam may be sequentially attached.

In the content of the method for manufacturing the pressure sensitive heating element, a description which is the same as the description of the configuration and effect of the pressure sensitive heating element is omitted.

Hereinafter, exemplary embodiments of the present disclosure will be described in detail so that those skilled in the art may easily implement the exemplary embodiments. However, the present disclosure may be embodied in various different forms and is not limited to the exemplary embodiments described herein.

### Preparation Example—Preparation of CNT Dispersion

0.1875 wt % of CNT (manufactured by JEO, 8A product) based on a total mass of the CNT dispersion was prepared and added to a solvent Cyclohexanone. In order to disperse CNT in the mixed solution, 0.75 wt % of a dispersant (BYK9077) based on the total mass of the CNT dispersion was further mixed. Then, the solution was pre-dispersed with a paste mixer and dispersed for 30 minutes through an ultrasonic dispersion device (40% amplitude based on 100 g).

### COMPARATIVE EXAMPLE

A binder (Songwon Industrial Co., Ltd., polyester type thermoplastic polyurethane elastomer (TPU), trade name: P1164D) was put in N-methyl-2-pyrrolidone (NMP) and heated and stirred to prepare a 6.25% of TPU solution. The solution was mixed with the CNT dispersion of Preparation Example at a mass ratio of 1:3 to prepare a coating solution. A polyurethane foam having a density of 0.036 g/cc was dip-coated with the prepared coating solution for 10 seconds, and then an excessively absorbed coating solution was removed. Thereafter, the polyurethane foam was dried at 120° C. for 20 minutes until the solvent was completely removed. The dip-coating process and the dry process were repeatedly performed 2 to 5 times according to target resistance to manufacture a CNT foam.

### Example 1

A CNT foam was prepared in the same manner as that of Comparative Example, except that a concentration of a TPU solution was 3.75%.

### Example 2

A CNT foam was prepared in the same manner as that of Comparative Example, except that a concentration of a TPU solution was 5%.

A table summarizing the composition and content of the coating solutions of Comparative Example and Examples 1 and 2 is as follows.

TABLE 1

| Solution | Ingredient | Example 1 | Example 2 | Comparative Example |
|---|---|---|---|---|
| CNT dispersion | CNT | 8A | 8A | 8A |
| | | 0.1875% | 0.1875% | 0.1875% |
| | dispersant | BYK9077 0.75% | BYK9077 0.75% | BYK9077 0.75% |
| | Solvent | Cyclohexanone | Cyclohexanone | Cyclohexanone |
| TPU solution | Binder | P1164D | P1164D | P1164D |
| | | 3.75% | 5% | 6.25% |
| | Solvent | NMP | NMP | NMP |

### Experimental Example 1

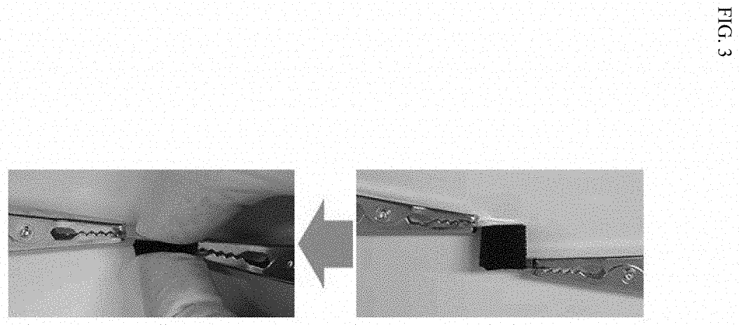

While repeatedly compressing each of the four different CNT foams prepared in Preparation Example and Examples five or more times in the method as in FIG. 3, a resistance reduction rate and resistance recovery characteristics according to the number of compressions of each CNT foam were measured. The CNT foam was compressed to about 50% of its original height. The measurement results are summarized and shown in Tables 2 and 3 below.

TABLE 2

| | Resistance | | | | | | | | | | | |
|---|---|---|---|---|---|---|---|---|---|---|---|---|
| | First | | | Second | | | Third | | | Fourth | | |
| | Before | After | | Before | After | | Before | After | | Before | After | |
| | com- | com- | Reduction | com- | com- | Reduction | com- | com- | Reduction | com- | com- | Reduction |
| | pression | pression | rate | pression | pression | rate | pression | pression | rate | pression | pression | rate |
| Target | (Ω) | (Ω) | (%) | (Ω) | (Ω) | (%) | (Ω) | (Ω) | (%) | (Ω) | (Ω) | rate |
| Example 1 | 311.53 | 82.9 | 73 | 336.17 | 72.07 | 79 | 334.27 | 67.1 | 80 | 333.63 | 65.17 | 80 |
| Example 2 | 460.33 | 137.53 | 70 | 520 | 130.73 | 75 | 519.67 | 120.17 | 77 | 523 | 117.87 | 77 |
| Comparative | 760.33 | 175.1 | 77 | 896.67 | 168.4 | 81 | 914.33 | 159.3 | 83 | 926 | 158.13 | 83 |
| Example | | | | | | | | | | | | |

TABLE 3

| | Resistance recovery rate after | | | |
|---|---|---|---|---|
| | compression restoration | | | |
| Target | First (%) | Second (%) | Third (%) | Fourth (%) |
| Example 1 | — | 92.09 | 100.57 | 100.19 |
| Example 2 | — | 87.04 | 100.06 | 99.36 |
| Comparative Example | — | 82.07 | 98.03 | 98.72 |

Referring to Table 2, it can be seen that, as the concentration of the TPU solution was increased from 3.75% to 5%, the resistance reduction rate during compression was reduced, so that the resistance reduction rate characteristics were improved. However, in the case of Comparative Example in which the concentration of the TPU solution was 6.25%, it can be seen that the resistance reduction rate during compression was increased to exhibit inferior characteristics compared to Examples.

Referring to Table 3, it can be seen that, as the concentration of the TPU solution was increased, the resistance recovery characteristics after compression were decreased, so that Comparative Example exhibits inferior characteristics compared to Examples.

### Example 3

As shown in FIG. 4, a front electrode having a width×length=210 mm×210 mm was prepared, and the CNT foam prepared in Example 1 was attached to the front electrode using a conductive or non-conductive adhesive to prepare a sample of a pressure sensitive heating element.

### Experimental Example 2

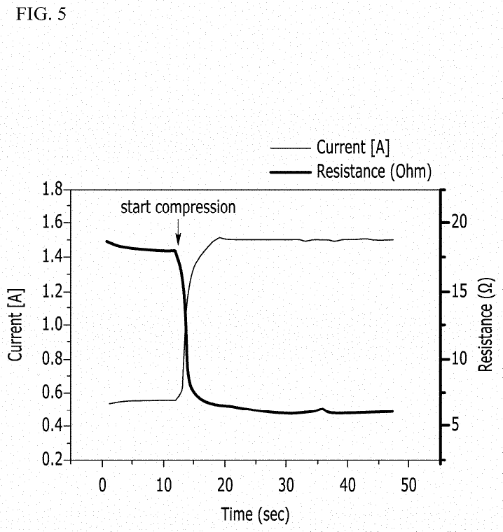

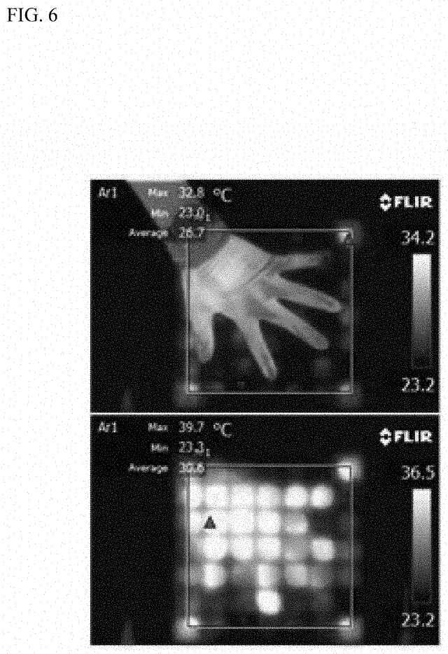

After installing the sample of the pressure sensitive heating element prepared in Example 3 in a black box not affected by ambient air and lighting, a thermal imaging camera (FLIR, product name: T420) was fixed with a tripod to start capturing an image. DC voltage was applied to the sample using a power supply (KEITHLEY, product name: 2260B-30-72) under test conditions of DC 10V and 1.5A limit. Thereafter, the foam was pressed to be sufficiently compressed with a hand wearing latex gloves, and thereafter, the hand was removed and a heating temperature and a heating distribution state of the sample were checked. Results thereof and captured infrared (IR) image are shown in FIG. 6. The power supply was connected to a computer to measure voltage and current changes during the test (using I.V. SOLUTION's program), and the results are shown in FIG. 5. FIG. 5 is a graph showing resistance and current graph data of an evaluation sample over time based on a resistance value calculated according to an equation of V=IR based on the measured voltage and current values. Also, characteristics of the pressure sensitive heating element sample prepared in Example 3 are shown in Table 4 below. Referring to FIG. 5, it can be seen that, when pressure was applied to the foam, a contact portion between conductive materials of a portion of the foam to which the pressure was applied was increased, and the amount of current through the portion was increased. When the amount of current was increased in this manner, heating takes place accordingly. Referring to FIG. 6, it can be seen that partial and selective heating took place only in the portion of the foam to which the pressure was applied.

TABLE 4

| TYPE | Whole type |
|---|---|
| Standard | 210 × 210 mm |
| Terminal resistance | 18 Ω |
| Test condition | DC |
| | 10 V, |
| | 1.5 A limit |
| maximum power | About 15 W |
| Electrode portion area | 42.6% |

### Example 4

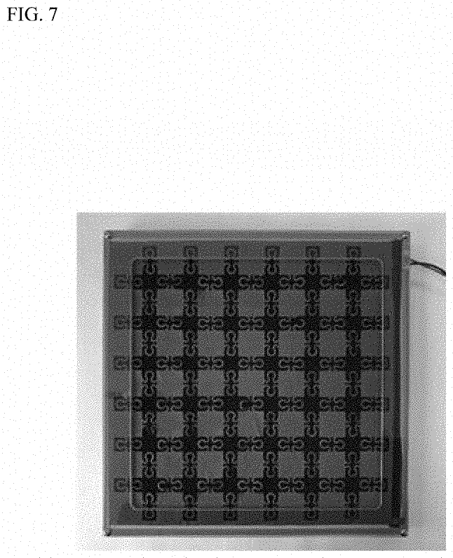

As shown in FIG. 7, a front electrode having a width×length=210 mm×210 mm was prepared, and the CNT foam prepared in Example 1 was attached to the front electrode using a conductive or non-conductive adhesive to prepare a sample of a pressure sensitive heating element. However, a polyurethane foam (density: 0.032 g/cc) having a lower density than that used in Example 1 was used.

### Experimental Example 3

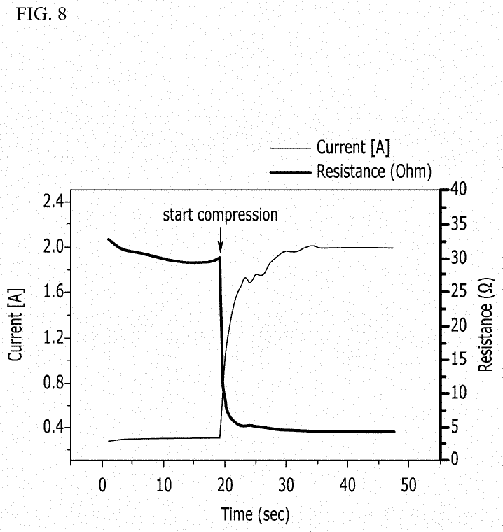

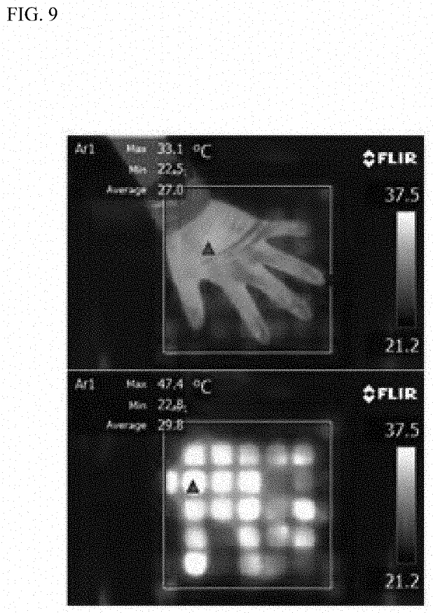

After installing the sample of the pressure sensitive heating element prepared in Example 4 in a black box not affected by ambient air and lighting, a thermal imaging camera (FLIR, product name: T420) was fixed with a tripod to start capturing an image. DC voltage was applied to the sample using a power supply (KEITHLEY, product name: 2260B-30-72) under test conditions of DC 9 V and 2 A limit. Thereafter, the foam was pressed to be sufficiently compressed with a hand wearing latex gloves, and thereafter, the hand was removed and a heating temperature and a heating distribution state of the sample were checked. Results thereof and captured infrared (IR) image are shown in FIG. 9. The power supply was connected to a computer to measure voltage and current changes during the test (using I.V. SOLUTION's program), and the results are shown in FIG. 8. FIG. 8 is a graph showing resistance and current graph data of an evaluation sample over time based on a resistance value calculated according to an equation of V=IR based on the measured voltage and current values. Also, characteristics of the pressure sensitive heating element sample prepared in Example 4 are shown in Table 5 below.

Referring to FIG. 8, it can be seen that, when pressure was applied to the foam, a contact portion between conductive materials of a portion of the foam to which the pressure was applied was increased, and the amount of current through the portion was increased. When the amount of current was increased in this manner, heating takes place accordingly. Referring to FIG. 9, it can be seen that partial and selective heating took place only in the portion of the foam to which the pressure was applied.

TABLE 5

| TYPE | Whole type |
|---|---|
| Standard | 210 × 210 mm |
| Terminal resistance | 32 Ω |
| Test condition | DC |
| | 9 V, |
| | 2 A limit |
| Maximum power | About 18 W |
| Electrode portion area | 42.6% |

### Example 5

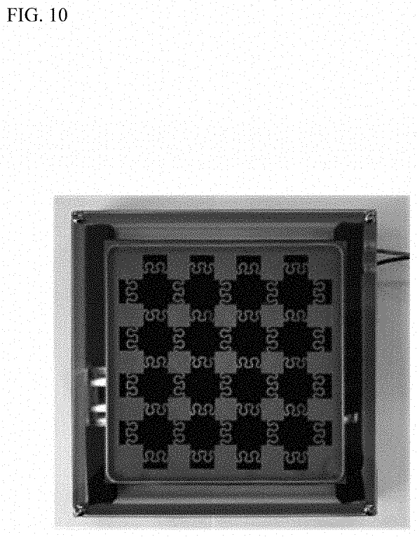

As shown in FIG. 10, a front electrode having a width×length=100 mm×100 mm was prepared, and the CNT foam prepared in Example 2 was attached to the front electrode using a conductive or non-conductive adhesive to prepare a sample of a pressure sensitive heating element.

### Experimental Example 4

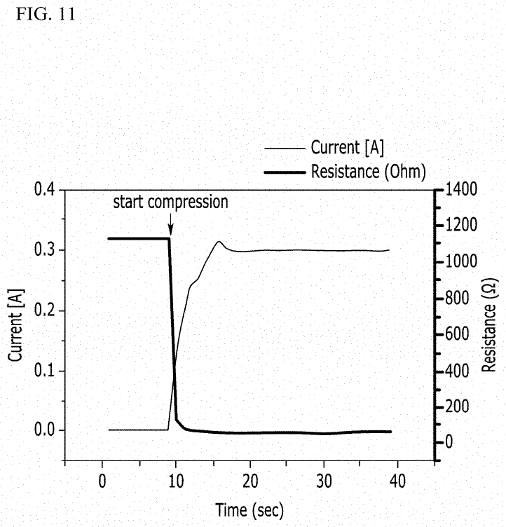

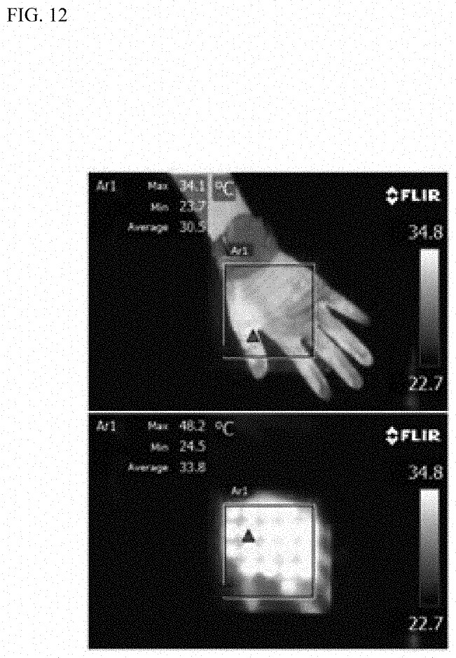

After installing the sample of the pressure sensitive heating element prepared in Example 5 in a black box not affected by ambient air and lighting, a thermal imaging camera (FLIR, product name: T420) was fixed with a tripod to start capturing an image. DC voltage was applied to the sample using a power supply (KEITHLEY, product name: 2260B-30-72) under test conditions of DC 17 V and 0.3 A limit. Thereafter, the foam was pressed to be sufficiently compressed with a hand wearing latex gloves, and thereafter, the hand was removed and a heating temperature and a heating distribution state of the sample were checked. Results thereof and captured infrared (IR) image are shown in FIG. 12. The power supply was connected to a computer to measure voltage and current changes during the test (using I.V. SOLUTION's program), and the results are shown in FIG. 11. FIG. 11 is a graph showing resistance and current graph data of an evaluation sample over time based on a resistance value calculated according to an equation of V=IR based on the measured voltage and current values. Also, characteristics of the pressure sensitive heating element sample prepared in Example 5 are shown in Table 6 below.

Referring to FIG. 11, it can be seen that, when pressure was applied to the foam, a contact portion between conductive materials of a portion of the foam to which the pressure was applied was increased, and the amount of current through the portion was increased. When the amount of current was increased in this manner, heating takes place accordingly. Referring to FIG. 12, it can be seen that partial and selective heating took place only in the portion of the foam to which the pressure was applied.

TABLE 6

| TYPE | Whole type |
|---|---|
| Standard | 100 × 100 mm |
| Terminal resistance | 1,310 Ω |
| test condition | DC |
| | 17 V, |
| | 0.3 A limit |
| Maximum power | About 4.9 W |
| Electrode portion area | 30.9% |

### Example 6

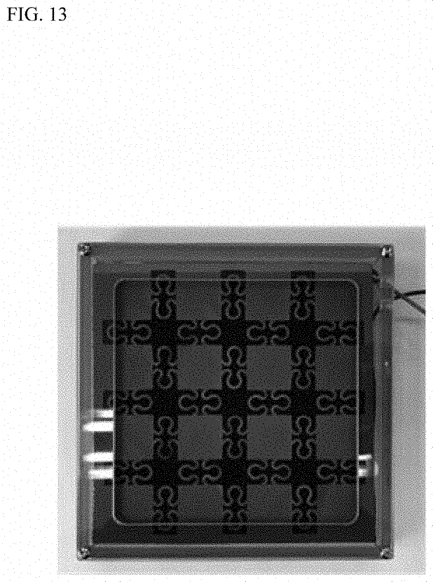

As shown in FIG. 13, a front electrode having a width×length=120 mm×120 mm was prepared, and the CNT foam prepared in Example 2 was attached to the front electrode using a conductive or non-conductive adhesive to prepare a sample of a pressure sensitive heating element. However, a polyurethane foam (density: 0.032 g/cc) having a lower density than that used in Example 2 was used.

### Experimental Example 5

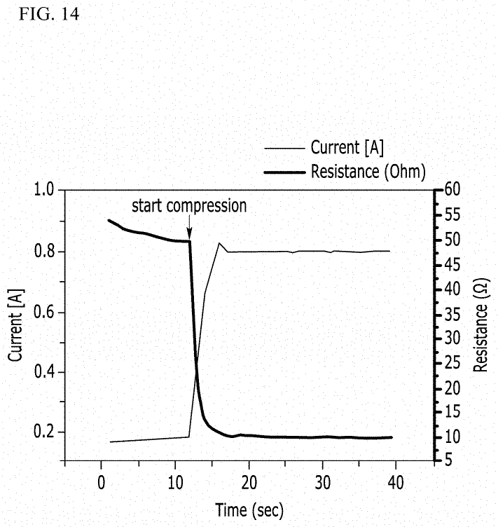

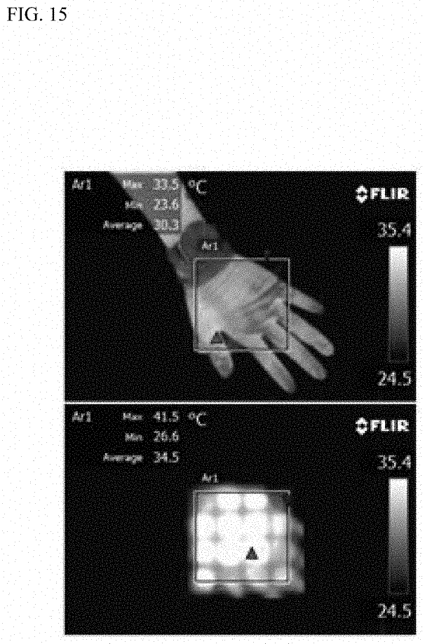

After installing the sample of the pressure sensitive heating element prepared in Example 6 in a black box not affected by ambient air and lighting, a thermal imaging camera (FLIR, product name: T420) was fixed with a tripod to start capturing an image. DC voltage was applied to the sample using a power supply (KEITHLEY, product name: 2260B-30-72) under test conditions of DC 9 V and 0.8 A limit. Thereafter, the foam was pressed to be sufficiently compressed with a hand wearing latex gloves, and thereafter, the hand was removed and a heating temperature and a heating distribution state of the sample were checked. Results thereof and captured infrared (IR) image are shown in FIG. 15. The power supply was connected to a computer to measure voltage and current changes during the test (using I.V. SOLUTION's program), and the results are shown in FIG. 14. FIG. 14 is a graph showing resistance and current graph data of an evaluation sample over time based on a resistance value calculated according to an equation of V=IR based on the measured voltage and current values. Also, characteristics of the pressure sensitive heating element sample prepared in Example 6 are shown in Table 7 below.

Referring to FIG. 14, it can be seen that, when pressure was applied to the foam, a contact portion between conductive materials of a portion of the foam to which the pressure was applied was increased, and the amount of current through the portion was increased. When the amount of current was increased in this manner, heating takes place accordingly. Referring to FIG. 15, it can be seen that partial and selective heating took place only in the portion of the foam to which the pressure was applied.

TABLE 7

| TYPE | Whole type |
|---|---|
| Standard | 120 × 120 mm |
| Terminal resistance | 50 Ω |
| Test condition | DC |
| | 9 V, |
| | 0.8 A limit |
| Maximum power | About 6.6 W |
| Electrode portion area | 46.9% |

The present disclosure is not limited to the exemplary embodiments and may be manufactured in various forms, and it will be understood by those of skill in the art to which the present disclosure pertains that the present disclosure may be implemented in other specific forms without changing the technical spirit or essential features of the present disclosure. Therefore, the exemplary embodiments described above are merely illustrative and should not be understood as a limitation of the present disclosure.

What is claimed is:

1. A pressure sensitive heating element comprising:
a front electrode; and
a foam including a conductive material attached to one or both surfaces of the front electrode.

2. The pressure sensitive heating element of claim 1, wherein:
the conductive material is located on an inner surface of the foam, and
when pressure is applied to the foam, an electrical contact of a certain level or higher is formed to supply current to the front electrode.

3. The pressure sensitive heating element of claim 1, wherein:
the front electrode includes:
a plurality of electrode surfaces;
a connection portion electrically connecting the plurality of electrode surfaces; and
a power connection portion configured to supply power to the front electrode.

4. The pressure sensitive heating element of claim 3, wherein:
an electrical contact of a certain level or higher is formed on a surface to which pressure is applied, among the plurality of electrode surfaces, to supply current to the front electrode.

5. The pressure sensitive heating element of claim 3, wherein:
a total area of the plurality of electrode surfaces is 25% to 50% of a total area of the front electrode.

6. The pressure sensitive heating element of claim 3, wherein:
the connection portion is in a form of a wire.

7. The pressure sensitive heating element of claim 3, wherein:
a first urethane film is attached to a surface to which the foam is not attached in the electrode surface and the power connection portion,
a second urethane film is attached to both surfaces of the connection portion.

8. The pressure sensitive heating element of claim 1, wherein:
the conductive material is carbon nanotube (CNT).

9. The pressure sensitive heating element of claim 1, wherein:
the foam is a polyurethane foam.

10. The pressure sensitive heating element of claim 9, wherein:
the density of the polyurethane foam is 0.03 g/cc to 0.04 g/cc.

11. A method for manufacturing a pressure sensitive heating element, the method comprising:
manufacturing a foam including a conductive material;
preparing a front electrode; and
attaching the foam to one or both surfaces of the front electrode.

12. The method of claim 11, wherein:
the manufacturing a foam including a conductive material includes:
preparing the foam;
preparing a coating solution; and
coating the prepared foam with the prepared coating solution.

13. The method of claim 12, wherein:
the preparing a coating solution includes:
mixing the conductive material, a dispersant, and a solvent to prepare a conductive material dispersion solution;
mixing a binder and the solvent to prepare a binder solution; and
mixing the conductive material dispersion solution and the binder solution.

14. The method of claim 13, wherein:
In the preparing a binder solution,
the binder is 3.5 parts by weight to 5.5 parts by weight based on 100 parts by weight of the binder solution.

15. The method of claim 13, wherein:
in the mixing the conductive material dispersion solution and the binder solution,
a mass ratio of the binder solution to the conductive material dispersion solution ranges from 2:1 to 4:1.

16. The method of claim 12, wherein:
the coating the prepared foam with the prepared coating solution includes:
dip-coating the foam with the prepared coating solution;
removing an excessively absorbed coating solution in the dip-coating; and
drying until the solvent is completely removed.

17. The method of claim 11, wherein:
in the attaching the foam to one or both surfaces of the front electrode,
the foam is attached using a conductive or non-conductive adhesive.
